(19) United States
(12) Patent Application Publication
(10) Pub. No.: US 2006/0015419 A1
(43) Pub. Date: Jan. 19, 2006

(54) Method for determining sales tax in automated purchasing systems

(75) Inventors: Stephen Graf, Neenah, WI (US); Deborah Boone, Evanston, IL (US); Quent Below, Knoxville, TN (US); Gail Giese, Hortonville, WI (US); Robert Q. Heglund JR., Appleton, WI (US)

Correspondence Address: DORITY & MANNING, P.A., POST OFFICE BOX 1449, GREENVILLE, SC, 29602-1449, US

(73) Assignee: KIMBERLY-CLARK WORLDWIDE, INC.

(21) Appl. No.: 10/882,107

(22) Filed: Jun. 30, 2004

(51) Int. Cl. G06Q 40/00

(52) U.S. Cl. 705/31

(57) ABSTRACT

A method for determining sales tax in an automated purchasing system includes the steps of populating data entries in a master transaction record for one or more commodity items. Exemplary populated data entries include material group, cost center code and delivery address. Data corresponding to cost centers are mapped to tax categories representative of abridged functional use classifications. The tax category, material group, and physical location information determined either from the delivery address or from the cost center code are provided from the automated purchasing system to a supplemental software interface. Such data availability is enabled by various combination of user exits, data tables, and importation from temporary memory associated with the automated purchasing system. A tax rate (e.g., state, county, city and/or district tax) is then determined for each commodity item based on the tax categories representative of various functional use information and selected data representative of physical location. Such tax rates may then be returned from the supplemental software interface to the automated purchasing system.

### BACKGROUND OF THE INVENTION

Many corporations today utilize automated purchasing systems that allow employees in a business environment to purchase supplies, manage inventories, and analyze procurement-related issues all via an integrated and automated system. Universal standards have been developed for such business software by a German-based company named Systeme, Andwendungen, Produkte in der Datenverabeitung, (Systems, Applications, Products in Data Processing). Their management software and systems are generally referred to as SAP® products of which various product versions and capabilities are currently known.

One particular aspect of SAP® systems relates to automated purchasing of supplies and other items. Since purchasing applications in SAP® systems are currently based on certain predefined universal standards, such systems sometimes fail to include every purchasing feature desired by specific users. As such, many corporations running SAP® software have a need for improved features for purchasing applications that are compliant with the universal standards established by SAP® software.

One specific example of an automated feature that is not currently provided for purchasing applications in SAP® business management systems is the determination of sales tax for a requested or purchased item where taxability status can vary dependent upon intended use. In current systems, the sales tax for a purchased item must be determined with manual oversight, considering the use of an item and how that use relates to laws in each respective state.

One previous customer solution has provided a system in which sales tax can be automatically determined based on a commodity code that contains information on what the item is. In some cases, the user may be prompted to enter an additional intended use code that may affect taxability. The information about the nature of the item (optionally including intended use information) can be combined with “where used” information to allow the system to automatically compare the items and their usage (as needed) with the requirements of tax laws to determine the correct sales tax. However, purchasing done with existing SAP® systems cannot perform the same or similar function in part because SAP® systems have not been designed with automated determination of sales tax in mind, and lack important features such as the ability to identify an intended use when it is relevant to tax laws. Rather, it is expected that the buyer will manually enter tax information. Unfortunately, central buyers may not understand how to apply this information to local tax laws, resulting in uncertainties, inefficiencies, and misapplied sales tax costs.

As such, a need exists for an automated purchasing system that combines the capabilities of SAP® systems with features that automatically determine sales tax and related information for purchases with different intended uses in such a system. More particularly, features are needed for integrating a customized tax determination routine with a given automated purchasing system without affecting the standard functionality of the given system.

### SUMMARY OF THE INVENTION

Objects and advantages of the invention will be set forth in part in the following description, or may be obvious from the description, or may be learned through practice of the invention. Automated purchasing software compatible with SAP® business management systems has been developed according to aspects of the present invention to allow information about the nature of an item to be combined with tax law information to automatically determine applicable sales tax. In the system of the present invention, an item to be purchased is assigned to a material group that identifies what the item is. A cost center code is also provided for each item, which can identify the type of operation or general nature of the facility where the item will be used. In one embodiment, cost center codes are not geographically unique. For example, a cost center code of 330 may refer to a diaper production line, regardless of which one of several mills hosts the line, while a cost center code of 206 may refer to a warehouse, regardless of which of many warehouses is intended.

Alternatively, cost center codes could be configured to convey unique geographical information. For example, a wood treatment facility in Alaska may have a code of 44267, while a similar facility in Georgia may have a code of 65412. In such cases, the cost center code could convey information about intended use of the item as well as the tax jurisdiction.

However, in many embodiments, it may be desirable to use a limited number of cost center codes that apply to many different locations, for cost center codes in SAP® are useful for many purposes other than sales tax calculation. Calculating cost accumulation and other financial measures can be simplified across a corporation when a limited number of standardized cost center codes are used.

The combination of material group codes and cost center codes can convey the information that was previously held in commodity codes and any associated intended use codes provided in the previously mentioned known customer solution. In general, commodity codes from a preexisting purchasing system can be mapped to material groups in the SAP system, and any needed information regarding intended use can be provided by selection of the appropriate cost center codes. For example, in a previous purchasing system a commodity code for a lift truck may have been associated with an additional intended use code to specify whether it was intended for use in a warehouse or in a manufacturing environment. Under the present invention for use with the SAP® system, the fork lift may now be assigned to a material group, and two or more cost centers codes can also be specified, including one for warehouses and one or more for specific or general manufacturing environments. Thus, in one embodiment of the present invention, a preliminary mapping step may be done to map commodity codes from a previously used purchasing system into a plurality of materials for use in SAP®, and a step of generating suitable cost centers for use in SAP® may also be carried out. Many hundreds or thousands of cost center codes may be required for a typical corporation.

Once cost center codes are generated, cost center categories can then be assigned. While SAP® may offer hundreds of cost center categories, in some embodiments of the present invention a relatively small number of cost center categories may be selected, such as less than 200, less than 100, less than 50, or less than 30. Exemplary cost center categories can include “Maintenance,” “Finished Production,” “Materials Handling,” and “Plant Overhead.”

Each cost center category is further assigned to a relatively general tax category that is descriptive of the broad nature of the item under consideration in terms of its relationship to tax laws. For example, we have found that six tax categories are generally useful, though greater or smaller numbers may be needed in other cases. The six categories that have proven generally useful for our purposes include: (1) Research and Engineering; (2) Corporate Administration; (3) Environmental; (4) Logistics; (5) Manufacturing; and (6) Materials Handling. The tax categories do not contain information about where the item is being used, but can be applied across a broad geographical extent.

Tax rates can be automatically determined by combining information about the material group with the tax category and physical location (tax jurisdiction). Physical location information may be obtained automatically from the purchase order (e.g., the delivery address on the invoice tab of the purchase order in SAP®), by manual entry of information, or by other means, including directly from the cost center code if cost center codes are configured to be geographically unique. The physical location information is used to access a database of tax law information to determine the correct sales tax for the material group under the appropriate tax category. A third-party database or software system can be provided to supply tax information as a function of physical location. Suitable commercial systems include Vertex® Sales Tax solutions of Vertex Inc. (Berwyn, Pa.), such as those described at http://www.vertexinc.com/Products/sales tax.asp (as viewed Jun. 8, 2004).

In accordance with one exemplary embodiment of the present invention, a method for determining sales tax in an automated purchasing system includes an initial step of providing data requesting the purchase of one or more commodity items. Such a request may be effected by populating data entries within a master transaction record, such as a purchase order. The plurality of data entries provided in the master transaction record include such information as a material group identifying the general nature of an item and a cost center code identifying the general nature of the facility where the item is to be used. The material group may be manually entered in the master transaction document or determined automatically by the automated purchasing system by another item identification variable. Each cost center code may be mapped to a tax category that is more particularly representative of the intended functional use of the item. In one embodiment, exemplary tax categories include one or more of research and engineering, corporate administration, environmental, logistics, manufacturing, and materials handling. The tax category, material group, and physical location information determined either from the cost center code or from delivery address information also populated in the master transaction document are then provided to a supplemental software interface. In one embodiment, such information may be provided by enabling user exits to pass the desired variables from the automated purchasing system to the supplemental software interface. In another embodiment, information is made available by creating a data table accessible by the supplemental software interface and populating various entries into the data table. Other variables, if needed, that cannot be imported into the data table because of their format type may be imported to the supplemental software interface from temporary memory. A tax rate is then determined for each commodity item based on the material group, tax categories and physical location, using a database of tax law information for the tax jurisdiction(s) associated with the selected physical location. Such tax rates may then be returned from the supplemental software interface to the automated purchasing system and optionally made available for other financial calculations within SAP® or other systems.

A related aspect of the subject method for determining sales tax in an automated purchasing environment concerns a computer-readable medium tangibly embodying one or more programs of instruction executable by a computer to perform method steps for determining sales tax in an automated purchasing system. The method embodied by the computer-readable medium and executed by a computer may include a first exemplary step of populating a plurality of data entries within a master transaction record for one or more commodity items. The plurality of data entries may includes a material group and a cost center code. Other exemplary steps include mapping the cost center code for selected commodity items to a tax category representative of functional usage of the associated commodity item, providing the mapped tax category, material group and physical location information representative of where a commodity will be used to a supplemental software interface, and determining a tax rate for the one or more commodity items from each respective tax category, material group and physical location information.

Other features and aspects of the present invention are discussed in greater detail below.

### BRIEF DESCRIPTION OF THE DRAWINGS

FIG. 1 provides a block diagram illustration of exemplary steps in one embodiment of a method for determining sales tax in an automated purchasing system in accordance with aspects of the present invention; and

FIG. 2 provides a block diagram illustration of more particular exemplary steps regarding how data entries are provided from a master transaction record to a supplemental software interface in accordance with one embodiment of the present invention.

### DETAILED DESCRIPTION OF THE PREFERRED EMBODIMENTS

Reference now will be made in detail to the presently preferred embodiments of the invention, one or more examples of which are illustrated in the accompanying drawings. Each example is provided by way of explanation of the invention, which is not restricted to the specifics of the examples. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. The same numerals are assigned to the same components throughout the drawings and description.

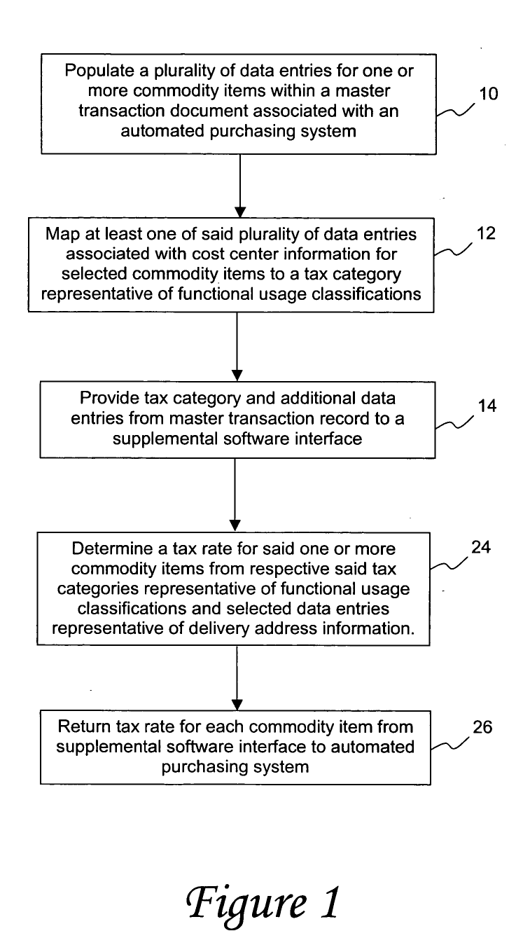

An embodiment of the subject method for determining sales tax in an automated purchasing system is shown in FIG. 1. Referring now to FIG. 1, a first step 10 in the subject sales tax determination method concerns commodity purchasing in an automated purchasing system, such as a purchasing system integrated within an SAP® management system. Conventional SAP® business management software provides, among others, the ability to store, retrieve, analyze and process corporate data for financial analysis, production, operation, and other business processes. These features may be provided in an Internet-enabled environment or via a comprehensive Web-based interface. Aspects of the subject invention focus on but are not limited to the purchasing, accounts payable, and logistics invoice verification (LIV) features of such an automated purchasing system. In further regard to step 10, a master transaction document is typically populated for purchase or analysis of one or more commodity items, whereby a plurality of data entries must be provided for each commodity item in the master transaction document. Such data entries may correspond to such information as the project identification, requesting cost center, purchase order number, internal order number, plant number, material group, controlling area and item number associated with each commodity item. It should be appreciated in accordance with the present invention that any combination of the aforementioned data variables or others not listed herein may be provided in step 10 of the subject method. Specific physical location information identifying where the commodity items are to be used may also be provided in the master transaction document populated in step 10, or may be provided in a purchasing order or manually entered.

In one exemplary embodiment, an item number is entered in step 10 into a master transaction document (e.g., a purchase order). Based on the entered item number, a material group that identifies what the item is may be assigned to the commodity item. In one embodiment, the material group assignment may be translated from a database provided in conjunction with the automated purchasing system. In another embodiment, the material group may be entered manually by a requisitioner in one of the plurality of data entries of the master transaction document. As such, population of data entries in step 10 including the material group and other data entries may be effected manually or may be determined automatically by the purchasing system from other manually entered information. In a still further exemplary embodiment, other specific data fields that are populated include a cost center code and/or a delivery address, one or both of which may provide physical location information about where the requisitioned commodity item will be used.

Referring still to FIG. 1, a next step 12 in the method for determining sales tax in an automated purchasing system concerns mapping a cost center code to a tax category. At least one of the data entries in the master transaction document whose fields are selectively populated in step 10 concerns cost center data (e.g., data from plant number, requesting cost center, controlling area, etc.). Another data variable available from some master transaction documents that may provide information about the cost center is a work breakdown structure (WBS) element, which is often used to plan, gather and track costs for a grant or contract, plant, project or agency. In one embodiment, cost center codes may correspond to multi-digit alphanumeric codes that provide a geographically unique identification for where a requisitioned item is to be used. In other embodiments, cost center codes may not be geographically unique, but do identify the type of operation or the general nature of the facility where the commodity item will be used. Once cost center codes are provided or automatically generated for each commodity item in the master transaction document, the cost center codes are mapped to one of a collection of given tax categories. In other words, data representative of how a commodity item is to be used (e.g., a manufacturing line, a warehouse, environmental purposes, etc.) helps determine what tax category should be associated with each commodity. In one embodiment, the functional use classification relayed by the broad tax category is selected from the following options: research and engineering, corporate administration, environmental, logistics, manufacturing, and materials handling. It should be appreciated that a greater or fewer number of specific tax categories may be utilized for certain applications. Broad tax categories mapped in step 12 typically do not contain information about where each commodity item is to be used, but may be applied across a broad geographical extent.

In some embodiments of the present technology, an intermediate step (not illustrated) of mapping each cost center code to a cost center category is performed before the broad tax category is assigned. Exemplary cost center categories can include “Maintenance”, “Finished Production”, Materials Handling”, and “Plant Overhead”. In some embodiments, there may be a greater number of cost center categories than tax categories to choose from for each commodity item. One specific example provides for about twenty cost center category options and about six tax category options.

Location-related information is another key variable used in determination of tax rates in accordance with the subject technology. Tax jurisdiction codes are determined by the automated purchasing system based on the associated delivery address (physical location) and cost center to determine what tax rates (including tax at the state, county, city and district levels) apply to each commodity. Physical location information can be determined from one or more of the data fields populated in step 10. In one embodiment, physical location information is determined from a delivery address provided in a purchase order or other master transaction document. In another embodiment, physical location information is determined from cost center codes when such codes provide a geographically unique identifier for various corporate facilities. When physical location information can be determined from more than one data variable, one of such variables may be programmed as a default variable. This default variable then overrides all others for use in combination with the broad tax category determined in step 12 to determine a relevant tax jurisdiction code and ultimate tax rate for each commodity item.

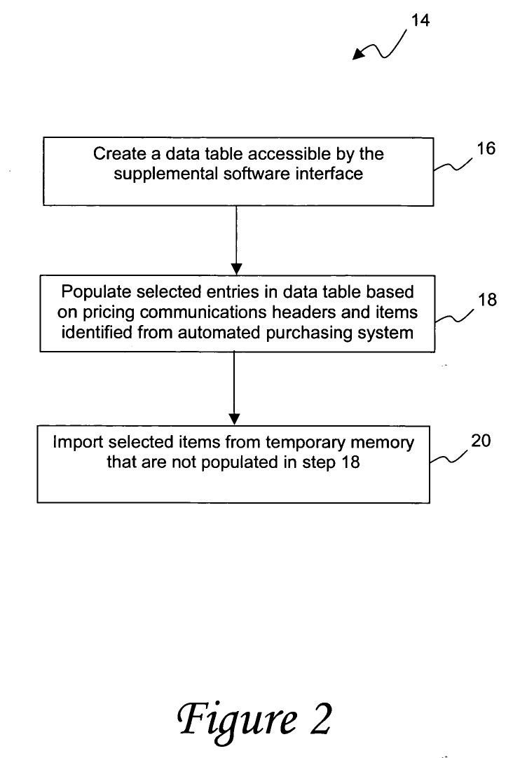

Referring still to FIG. 1, a still further step 14 in the subject method for determining sales tax is to provide the determined tax category from step 12 as well as selected additional data entries as populated in step 10 in the master transaction document to a supplemental software interface. The supplemental software interface is the program used in accordance with the present invention to ultimately determine tax rates for each commodity item assuming that no provisions are directly available in the automated purchasing system. FIG. 2 depicts in more particular detail exemplary steps associated with the step 14 of providing information to the supplemental software interface.

Referring now to FIG. 2, a first step 16 associated with providing data to the supplemental software interface is to create a data table to be accessible by the supplemental software interface. A second step 18 is to populate selected entries in the data table based on data provided in the master transaction document in the automated purchasing system. Select entries populated in step 18 are those that have defined data structures (e.g., KOMK and KOMP data structures in SAP® applications) such as pricing communication headers and pricing communication items identified in the automated purchasing system. Such data may be made available by employing user exits in the automated purchasing system. User exits are defined by code locations in the automated purchasing system's software program where a customer can arrange for a supplemental custom program to be called. A user exit allows a customer's developer and thus the supplemental program to access program components and data objects within the automated purchasing system. Program components and data objects desired for tax determination purposes in the subject supplemental software interface include commodity code data and/or corresponding tax category, material group and physical location information. User exits can access such information either by directly calling the data from the automated purchasing system or by establishing customized tables including the desired data variables. The latter of these options is depicted in FIG. 2, although it should be appreciated that the present invention is not limited to this particular methodology. Those data entries that are not populated in step 18 (e.g., those without specific data structures for access via user exits) may be imported to the data table created in step 16 from temporary memory, as represented by step 20 in FIG. 2.

With further reference to the exemplary steps of FIG. 2, it should be noted that different data entries may be captured from different locations in the automated purchasing system for subsequent availability to the supplemental software interface depending on the transaction type. For example, for purchasing transactions, the item number, cost center, controlling area, WBS element and internal order number must all be imported from temporary memory via step 20. For logistics invoice verification, the purchase order item is read to get a plant number and material group. For non-purchase-order transactions, the material group, cost center, controlling area, WBS element and internal order number are typically imported from temporary memory. Furthermore, most transactions have an associated account assignment indicator. Depending on this indicator, the cost center code or cost center category (which is mapped to a tax category in step 12) may be found in a different location, such as but not limited to the WBS element or internal order number.

Referring again to FIG. 1, a next exemplary step in the subject method for determining sales tax is to determine a tax rate for the various commodity items. The tax rate is determined from three general types of information provided in the automated purchasing system: commodity usage information representative of the nature of the item (e.g., a material group), cost center information or a corresponding tax category representative of the intended use of the item, and physical location information representing where an item will be used. The physical location information may be obtained from various locations, including but not limited to a delivery address when provided on a purchase order or other master transaction document or the cost center code when such code is geographically unique. The cost center is already mapped in step 12 to a general tax category. It should be appreciated that for some combinations of information regarding a specific commodity item, the determined tax rate is equal to zero.

As previously mentioned, material group information and cost center information may be entered when the material is ordered. This information is then combined with the physical location to determine an appropriate tax rate. Functional usage classification associated with the cost center, the cost center category, and the tax category are important because it can determine when a purchase is exempt from sales tax. For example, materials purchased by a department for use in manufacturing a finished good may be eligible for a tax-exempt distinction, while departments utilizing a commodity or material for research-related activities must pay applicable sales tax. Additional tables available in the supplemental software interface that contain a repository of tax law information are consulted to determine the appropriate tax rate. In one embodiment, a third-party database or software system can be provided to supply tax information as a function or physical location. Suitable commercial systems include Vertex® Sales Tax solutions of Vertex Inc. (Berwyn, Pa.), such as those described at http://www.vertexinc.com/Products/sales tax.asp (as viewed on Jun. 8, 2004.) This tax rate information may then be repopulated back to the automated purchasing system for each commodity line item in the master transaction document, as represented in final exemplary step 26 of FIG. 1.

Additional steps and features that may be incorporated in the subject method for determining sales tax include the steps of updating the ship-to jurisdiction code in the supplemental software interface (either via a purchasing user exit in the automated purchasing system, a batch job or a substitution rule) and generation of a report of taxes paid to various vendors.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A method for determining sales tax in an automated purchasing system, said method comprising the steps of:
populating a plurality of data entries within a master transaction record for an automated purchasing system for one or more commodity items, wherein said plurality of data entries includes at least a material group and a cost center code;
mapping said cost center code for selected commodity items to a tax category representative of functional usage of the associated commodity item;
providing said tax category, said material group and physical location information representative of where a commodity will be used to a supplemental software interface; and
determining a tax rate for said one or more commodity items from each respective said tax category, material group and physical location information.

2. The method of claim 1, wherein said plurality of data entries further comprise information corresponding to one or more of project identification, requesting cost center, purchase order number, internal order number, plant number, controlling area, delivery address and item number.

3. The method of claim 1, further comprising the step of enabling user exits in said automated purchasing system such that selected data populated in said master transaction record is available to said supplemental software interface.

4. The method of claim 1, further comprising a step of mapping said cost center code for selected commodity items to a cost center category.

5. The method of claim 1, wherein said tax category is selected from a group comprising research and engineering, corporate administration, environmental, logistics, manufacturing, and materials handling.

6. The method of claim 1, wherein each cost center code is geographically unique and the physical location information relayed in said providing step is determined from the cost center code for selected commodity items.

7. The method of claim 1, wherein said plurality of data entries further includes a delivery address and wherein the physical location information relayed in said providing step is determined from the delivery address populated in the master transaction document.

8. The method of claim 1, wherein said providing step further comprises the steps of:
creating a data table accessible by said supplemental software interface;
populating selected entries in said data table based on pricing communication headers and items identified from the automated purchasing system; and
importing selected items from temporary memory that are not populated in said populating step.

9. The method of claim 8, wherein the pricing communication headers and items identified from the automated purchasing system are made available by user exits within the automated purchasing system.

10. The method of claim 1, wherein said automated purchasing system comprises an SAP® brand application and wherein said supplemental software interface is compatible with said SAP® brand application.

11. The method of claim 1, further comprising the step of returning said tax rates determined for said one or more commodity items from the supplemental software interface to the automated purchasing system.

12. A method for determining sales tax in an automated purchasing system, said method comprising the steps of:
completing a purchase order to request one or more commodity items, whereby at least an item identification variable, a cost center identification variable, and a physical delivery address is provided for each commodity item in the purchase order;
mapping the item identification variable for selected of the requested commodity items to a material group indicative of the general nature of the requested item;
mapping the cost center identification variable for selected of the requested commodity items to a broad tax category indicative of the intended use of the item; and
accessing a supplemental database of tax law information to determine a sales tax from the material group, broad tax category and physical delivery address for selected commodity items.

13. The method of claim 12, further comprising a step of mapping said cost center identification variable for selected commodity items to a cost center category.

14. The method of claim 12, wherein said broad tax category is selected from a group comprising research and engineering, corporate administration, environmental, logistics, manufacturing, and materials handling.

15. The method of claim 12, wherein said providing step further comprises the steps of:
creating a data table accessible by said supplemental database;
populating selected entries in said data table based on pricing communication headers and items identified from the automated purchasing system; and
importing selected items from temporary memory that are not populated in said populating step.

16. The method of claim 15, wherein the pricing communication headers and items identified from the automated purchasing system are made available by user exits within the automated purchasing system.

17. The method of claim 12, wherein said automated purchasing system comprises an SAP® brand application and wherein said supplemental database is compatible with said SAP® brand application.

18. The method of claim 12, further comprising the step of returning said tax rates determined for the one or more commodity items from the supplemental database to the automated purchasing system.

19. A computer-readable medium embodying one or more programs of instruction executable by a computer to perform method steps for determining sales tax in an automated purchasing system, said method comprising the following steps:
populating a plurality of data entries within a master transaction record for an automated purchasing system for one or more commodity items, wherein said plurality of data entries includes at least a material group and a cost center code;
mapping said cost center code for selected commodity items to a tax category representative of functional usage of the associated commodity item;
providing said tax category, said material group and physical location information representative of where a commodity will be used to a supplemental software interface; and
determining a tax rate for said one or more commodity items from each respective said tax category, material group and physical location information respective said tax category, material group and physical location information.

20. The computer-readable medium of claim 19, wherein said method further comprises a step of enabling user exits in said automated purchasing system such that selected data populated in said master transaction record is available to said supplemental software interface.

21. The computer-readable medium of claim 19, wherein said method further comprises a step of mapping said cost center code for selected commodity items to a cost center category.

22. The computer-readable medium of claim 19, wherein said material group provided in the plurality of data entries is manually entered in the master transaction document.

23. The computer-readable medium of claim 19, wherein said material group provided in the plurality of data entries is determined automatically from an item identification variable that is manually entered in the master transaction document.

24. The computer-readable medium of claim 19, wherein said tax category is selected from a group comprising research and engineering, corporate administration, environmental, logistics, manufacturing, and materials handling.

25. The computer-readable medium of claim 19, wherein each cost center code is geographically unique and the physical location information relayed in said providing step is determined from the cost center code for selected commodity items.

26. The computer-readable medium of claim 19, wherein said plurality of data entries further includes a delivery address and wherein the physical location information relayed in said providing step is determined from the delivery address populated in the master transaction document.

27. The computer-readable medium of claim 19, wherein said providing step further comprises the steps of:
creating a data table accessible by said supplemental software interface;
populating selected entries in said data table based on pricing communication headers and items identified from the automated purchasing system; and
importing selected items from temporary memory that are not populated in said populating step.

28. The computer-readable medium of claim 19, wherein the programs of instruction embodied within the computer-readable medium are compatible with an SAP® brand purchasing application.

29. The computer-readable medium of claim 19, wherein said method further comprises the step of returning said tax rates determined for said one or more commodity items from the supplemental software interface to the automated purchasing system.
